(19) United States
(12) Patent Application Publication
(10) Pub. No.: US 2015/0204482 A1
(43) Pub. Date: Jul. 23, 2015

(54) GAS SUPPLY DEVICE

(71) Applicant: LINDE AKTIENGESELLSCHAFT, Munich (DE)

(72) Inventor: Thomas Bickford Holbeche, Church Crookham (GB)

(21) Appl. No.: 14/425,121

(22) PCT Filed: Sep. 5, 2013
(86) PCT No.: PCT/EP2013/068332

§ 371 Date: Mar. 2, 2015

(30) Foreign Application Priority Data
Sep. 5, 2012 (GB) 1215885.3

(51) Int. Cl. F17C 1/00; B65B 7/28; B65B 31/00

(52) U.S. Cl. CPC F17C 1/00; B65B 31/003; B65B 7/2842; F17C 2201/0109; F17C 2201/058; F17C 2203/0617; F17C 2205/0314; F17C 2205/0308; F17C 2205/0335; F17C 2205/0394; F17C 2270/0736

(57) ABSTRACT

A gas supply device comprises a gas storage capsule seated by a pierceable, malleable closure disc that is crushed by a cap housing a valve member in an axial passage and typically making a fixed and permanent engagement with the capsule. The valve member is integral with or carries a forward disc-piercing needle and is able to be urged by application of a disc-piercing force to pierce the disc to release gas from the capsule. The valve member has a rearward end which is normally biased by a compression spring into a valve-closing engagement with an inner surface of the cap. The valve therefore closes if the disc-piercing force is withdrawn.

This invention relates to a gas supply device, particularly one including a capsule for storing a gas under pressure, the capsule typically being of a size and weight that can be readily held in the palm of a user's hand.

Such a capsule is commonplace and conventionally has a closure at its mouth in the form of a diaphragm that can be pierced in order to release gas. The diaphragm is typically welded or otherwise bonded to the capsule. The filling is conducted in the absence of the diaphragm and once the capsule has been charged with the necessary mass of gas, the diaphragm is positioned on the capsule and welded or otherwise bonded to it. Capsules containing, for example, carbon dioxide or nitrous oxide at a pressure typically in the order of 60 bar are well known. Such capsules typically used in conjunction with a separate unit for piercing the diaphragm, the separate unit being incorporated into the device to which the gas is to be delivered, or into a separate device which can mate with the unit in which the gas is to be used.

In a typical arrangement, this engagement of the capsule from the piercing unit results in the loss to the atmosphere of residual gas in the cylinder through the pierced diaphragm. An example of such an arrangement is, for example, disclosed in GB-A-971 161. A further disadvantage of such arrangements is that because the seal (between the capsule and the piercing unit) and of the piercing action are made essentially simultaneously, there is a risk that the diaphragm is pierced before a good face seal between the capsule and the piercing unit is effected, allowing high pressure gas to escape between the capsule and the piercing unit. Such escape is potentially hazardous. In addition, the escaping gas can penetrate screw threads between the capsule and the piercing unit to create difficulty in tightening the capsule further as a result of the gas pressure acting on the threads.

A yet further disadvantage is that reuse of a spent capsule requires removal of the remnants of the diaphragm and welding or otherwise bonding a new diaphragm to the capsule in order to reseal it.

According to the present invention there is provided a gas supply device comprising:
a capsule for storing gas under pressure, the capsule having a mouth;
a closure at the mouth of the capsule in the form of a pierceable, malleable, closure disc;
a cap able to be brought into engagement with the capsule to crush the pierceable, malleable closure disc and thereby seal the capsule;
a gas passage through the cap; and
a valve member in the gas passage, the valve member being integral with or carrying a forward disc-piercing member, and being able to urged by application of a disc-piercing force to cause the disc-piercing member to pierce the disc and thereby release gas from the capsule into the gas passage, and having a rearward face which on removal of the disc-piercing force is able to be urged into a valve-closing position in which gas is retained under pressure in the capsule.

The invention also provides a malleable, pierceable closure disc for use as a closure in a gas supply device according to any one of claims 1 to 17 below, the disc comprising filling grooves and a weakened, pierceable portion.

The invention further provides a method of charging with gas a gas supply device according to any one of claims 1 to 19 below, the malleable, pierceable closure disc being in accordance with claim 18 below, the method comprising:
a) assembling the gas supply device with the malleable, pierceable disc positioned over the mouth of the gas capsule.
b) supplying gas under pressure to the side of the valve member remote from the gas capsule, thereby causing the rearward lace of the valve member to move out of its valve closing position to permit gas to flow past the valve member through the filling grooves of the malleable, pierceable closure disc;
c) ceasing the supply of gas thereby causing the valve member to return to its valve-closing position; and
d) tightening the cap on the capsule to crash and deform the malleable, pierceable closure disc, thereby making a gas tight closure between the malleable, pierceable closure disc and the gas capsule, thus eliminating the filling grooves.

A gas supply device according to the invention is able to retain for at least a period of time gas in the capsule if the disc-piercing force is withdrawn.

The cap typically has an external surface having a configuration enabling the gas supply device to be coupled to another device in which the gas is to be used. To this end, the cap has a coupling nozzle which conveniently has an external screw thread. The internal surface of the cap typically also has a screw-thread able to engage a complementary screw-thread on the external surface of the capsule. If desired, the external surface of the cap may also be provided with drive splines to facilitate mechanical tightening of the cap.

The disc preferably has a configuration adapted to permit filling of the capsule with gas under pressure after assembly of the gas supply device but before a sealing engagement of the disc to the capsule is made. To this end, the disc may have a wavy or notched edge which, when the capsule is being filled with gas, allows the gas to pass under the disc into the capsule. In a typical arrangement, once the capsule is filled, tightening of the cap crushes the disc against the mouth of the capsule, so deforming the disc that a peripheral seal is made.

If desired, the disc may have a down-turned rim to facilitate location of the disc over the month of the capsule. Another advantage of such a configuration is that filling grooves or notches can conveniently be provided in the rim.

The disc may be formed of any malleable metal, for example, aluminium, a malleable alloy based on aluminium, copper, or a malleable alloy based on copper. If desired, the materials of the disc, capsule and cap may be selected such that the disc but not the cap and capsule is soluble in chosen acid or alkaline.

The disc may have a central pierceable area of reduced thickness so as to facilitate its puncture by the piercing member.

The valve member is typically attached to or integral with a valve spindle, to which spindle the disc-piercing force can be applied. Typically, the arrangement is such that the act of completing the coupling of the disc supply device according to the Invention to a gas-using device causes the disc-piercing force to be applied.

Typically, a gas supply device according to the invention includes a spring which has a bias in a valve-closing direction. The spring may be a compression spring. The compression spring may sit on the disc. This arrangement can help to prevent displacement of the disc during filling.

The rearward face of the valve member typically seats against an elastomeric O-ring seal. The O-ring seal may, when the valve is closed, be held under compression against an internal surface of the cap. In other embodiments, the rearward face of the valve member can carry an elastomeric O-ring seal which is held under compression when the valve member seats against an internal surface of the cap.

In some embodiments of the gas supply device according to the invention, the forward face of the valve member is integral with a piercing needle that acts as the disc-piercing member. In other embodiments, the forward lace of the valve member carries a piercing needle. The piercing needle may be hollow or formed of at least one longitudinal groove to facilitate the passage of gas out of the capsule on die piercing of the disc. If the said external surface of the cap which is to be coupled to a gas using device is formed with a coupling screw thread, the axial extent of that screw thread Is conveniently greater than the distance travelled by the valve member form its disc-piercing position to its valve-closing position. This arrangement enables the capsule to be securing coupled to the other device before the disc can be pierced.

In embodiments of the gas supply device according to the invention in which the valve member is connected to or integral with a valve spindle, the valve spindle being displaceable, the spindle preferably does not protrude out of the cap even when the valve is in its closed position. The valve therefore has protection from damage in the event of the capsule being accidentally dropped.

A gas supply device according to the invention will now be described by way of example with reference to the accompanying drawings, in which:

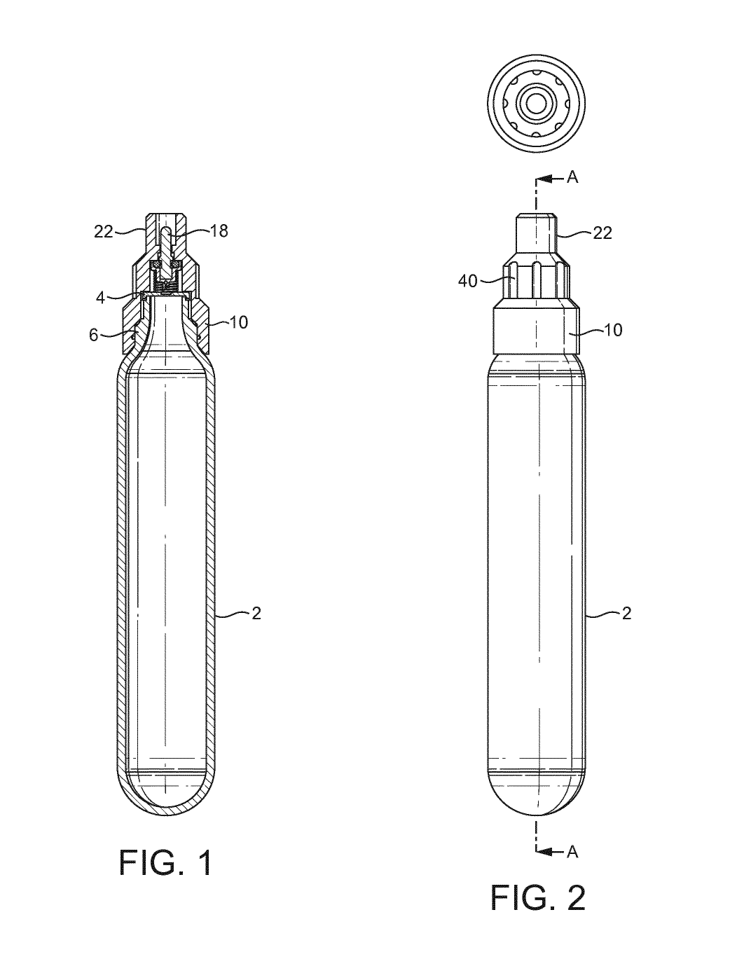

FIG. 1 is a general schematic, sectional side elevation of a gas supply device according to the invention;

FIG. 2 is a general, schematic, side elevation, not in section, of the gas capsule shown in FIG. 1.

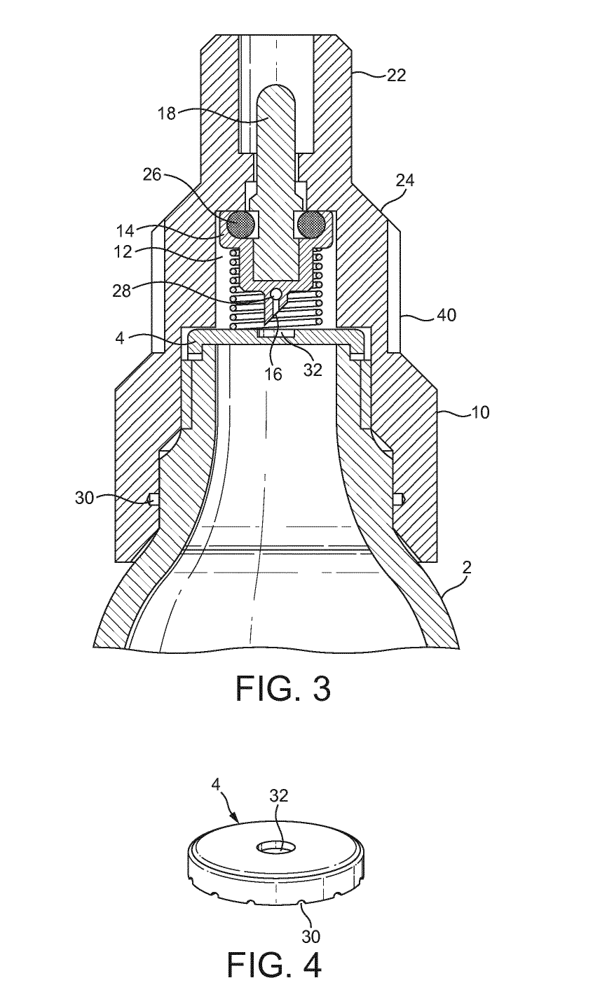

FIG. 3 is an enlarged sectional side elevation of the head of the gas supply device shown in FIGS. 1 and 2.

FIG. 4 is a schematic perspective view of the capsule closure disc shown in FIG. 3; and

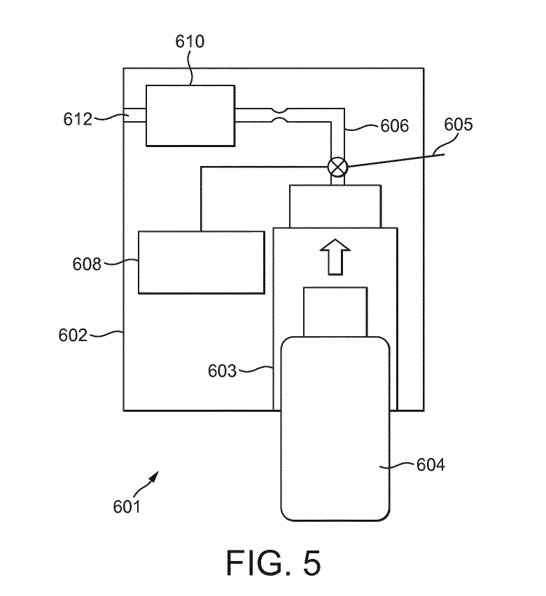

FIG. 5 is a schematic drawing of an atmospheric pressure non-thermal gaseous plasma generating device which may be coupled to a gas supply device according to the invention.

The drawings are not necessarily to scale.

Referring to FIGS. 1 to 4 of the drawings, a gas supply device according to the invention comprises a gas capsule for storing a gas under pressure. In FIGS. 1 to 3, the capsule is shown after it has been sealed. The gas capsule 2 has a closure 4 at its mouth to effect such sealing, the closure 4 being in the form of a malleable, pierceable disc (see FIG. 4). FIG. 4 shows the pierceable disc before it seals the capsule 2. The disc 4 may be provided with a downturned rim as shown in FIGS. 3 and 4 or in an alternative embodiment (not shown) may be flat with a wavy or notched edge.

The capsule 2 is of a size and weight such that it can be held comfortably in the palm of the human hand. It typically has a water capacity in the range of 5-60 ml. The capsule 2 stores chosen gas under pressure. The storage pressure may be in the range of from under 25 bar to over 300 bar. The thickness and material of construction of the walls of the capsule 2 are selected so as to withstand the chosen storage pressure. The capsule 2 is typically formed of aluminium, or aluminium-based alloy, or a suitable steel, such as stainless steel. The capsule 2 may be made by known manufacturing processes, for example, by deep drawing. The capsule 2 may be filled with any chosen gas. Some non-permanent gases may liquefy when subjected to the chosen storage pressure. Accordingly, the capsule may store the gas in liquefied state. If, however, the gas or gas mixture to be stored is a permanent gas, the gas will remain in gaseous state at the storage pressure.

With reference to FIG. 3 of the drawings, the mouth of the capsule 2 is provided at the ends of the capsule 2. The mouth has a circular opening defined by an annular face 7. A cap 10 crushes the malleable disc 4 against the face 7 so as to seal the capsule 2 and retain its contents. The disc 4 is typically formed of a malleable metal such as aluminium, a malleable alloy based on aluminium, copper or a malleable alloy based on copper.

The exterior surface at the end 6 is provided with a screw thread. It engages a complementary screw thread on the cap 10. The cap 10 has a passage 12 formed therethrough and houses a valve, as will be described below. The longitudinal axis for the passage 12 is coaxial with longitudinal axis of the capsule 2. The screw-threaded engagement between the capsule 2 and the cap 10 is such that a user cannot normally unscrew the cap 10 from the capsule 2. To this end, an adhesive is typically employed between threads 50 as to bond the cap 10 to the end 6 of the capsule 2. The cap 10 is thus fixedly and permanently secured to the capsule 2. A user of the gas supply device shown in the drawings is not able solely by manual means to unscrew or separate the cap 10 from the capsule 2.

The cap 10 houses a valve member 14 within the passage 12. The valve member 14 is integral with a disc-piercing needle 16. The valve member 14 is carried by (or is integral with) a valve spindle 18. The spindle 18 is entirely contained within the passage 12 and is coaxial with the capsule 2. The cap 10 has an integral nozzle 22 into which the end of the spindle 18 remote from the valve member 20 extends. The nozzle 22 may have a screw-threaded surface and, when it is desired to deliver gas, may be engaged with an external device (not shown) to which it is desired to supply gas from the capsule 2. An axial compression spring 24 is located within the cap 10. One end of the compression spring 24 sits on the disc 4 and the other end bears against the valve member 14 and biases its rearward end into a sealing engagement with the interior surface of the cap 10. The seal is typically made through an elastomeric O-ring 26. The compression spring 24 holds the valve member 20 in a position such that the needle 16 does not contact the disc 4 if no disc-piercing force is being exerted on the spindle 18.

The user device (not shown) is formed with a connector including a probe which is able to bear against the spindle to cause it to move the O-ring 26 out of valve-closing engagement with the inner surface of the can 10 and at the same tune to advance the piercing needle 16 towards the disc 4. If the disc 4 has not previously been pierced, the displacement of the spindle 18 drives the piercing needle through the disc 4 to form an aperture in that disc through which gas can pass. In one embodiment, the piercing needle 16 is hollow but has an orifice 28 formed therein to allow gas under pressure to flow through the needle 16 and the orifice 28 into the interior of the cap 10 and past the valve member 14 into the nozzle 22. In an alternative embodiment (not shown) the piercing needle 16 may be formed with one or more longitudinal grooves (not shown) enabling pressurised gas released from the capsule 2 by the piercing of the disc 4 to follow a similar path to that described above.

Although gas may continue to flow from the gas capsule 2 to the user device (not shown) until the pressure in the gas capsule no longer exceeds that in the user device, it is also possible to deliver a limited dose of gas from the gas capsule 2. The above may be limited by disconnecting the user device from the nozzle 22. This disconnection allows the bias of the compression spring 24 to return the valve member 20 to a valve closing position. Now that the disc 4 has been pierced, the valve closing action of the spring 24 will be enhanced by the pressure of the gas in the gas capsule 2. In order to eliminate or keep down leakage of gas from the interior of the cap through the screw threads by which the end 6 of the gas capsule 2 engages the inner surface of the cap 2, an O-ring seal 30 is held under compression between the end 6 and the inner surface of the cap 2. When it is desired to deliver another dose of gas from the gas capsule 2, the user device may simply be reconnected to the nozzle 22 with the result that the probe from the user device (not shown) displaces the spindle 18 in a valve-opening direction against the bias of the compression spring 24 and the pressure of the gas in the cap 10.

It Is a feature of the device according to the invention that the cap 10 is able to function as a filling valve for the gas capsule 2. Typically, an empty capsule 2 is held vertically in a suitable jig (not shown) and the disc 4 located over the mouth of the capsule 2. If desired, the disc 4 may have a downturned rim so as to facilitate its location. The cap 10 is then screwed onto the end 6, but not all the way, so that the tip of the piercing needle 16 does not contact the disc 4. A filling connector (not shown) is engaged with the nozzle 22. The filling connector has an internal probe, which when the filling connector is fully engaged with the nozzle 22, is able to displace the spindle 18 by a sufficient distance to open the valve but not by so much as to cause the piercing needle 16 to engage the disc 4. Further, in this position, the disc 4 is not subjected to any crushing force.

As shown in FIG. 4, the disc 4 is formed with several radial filling grooves 30 extending from its periphery inwards. These filling grooves provide a passage for gas into and out of the gas capsule during a normal filling operation. In such a filling operation, the capsule is typically first evacuated so air is typically extracted via a filling connector (or adaptor). When this has been done, the filling connector is placed in communication with a source of the pressurised gas to be stored in the capsule with the result that the gas flows through the filling grooves 30 into the capsule. When die pressure in the capsule has equalised with that of the source of the gas, the cap 10 is then fully tightened on the gas capsule 2. To this end, the exterior surface of the cap 10 may be provided with drive splines 40, to enable the tightening to be performed using a torque wrench. Typically, prior to the fitment of the cap 10 to the capsule 2, a suitable adhesive supplied to the screw threads by which the engagement is made. The adhesive of choice Is typically a high strength thread-locking compound. This adhesive is allowed or caused to cure, so that the cap 10 is fixedly and permanently secured to the gas capsule 2. A user is therefore not able solely by manual means to unscrew or separate the cap 10 from the capsule 2. The cap 10 thus serves as a protection device for the closure 4. Once the cap is fully tightened, the filling connector may be removed from engagement with the nozzle 22 with the result that the compression spring, aided by the pressure in the cage 10 moves the valve member 14 back to its valve-closing position. The filling connector is so configured that its connection urges the valve member 14 forward a sufficient distance to allow passage of gas into the gas capsule but an insufficient distance to cause the closure 4 to be pierced by the needle 16.

The act of fully tightening the cap on the capsule 2 has the effect of crushing the disc 4 to make a seal over the face 7 of the mouth of the gas capsule 2, thus preventing the escape of gas from the capsule 2. One of the advantages of this arrangement is that it facilitates reuse of a spent gas supply device according to the invention because the disc 4 is not welded or otherwise bonded to the gas capsule 2. Such a spent gas supply device may first be treated to weaken the adhesive bond between the capsule 2 and the cap 10. Typically, the adhesive bond may be weakened sufficiently by the application of heat. The cap 10 may then be unscrewed from the capsule 2 and the disc 4 removed. If desired, the removal of the disc 4 may be effected chemically by treatment with a suitable acid or alkali. The gas supply device may then be reassembled as described above using a replacement disc 4 and a replacement cap 10 unit.

In order to facilitate its piercing, the disc 4 may have a coined or otherwise weakened central region 32.

A gas assembly device as shown in the drawings is particularly safe to use because any inadvertent uncoupling of the device from a user device will cause the valve within the cap 10 to close thereby protecting the user from undesired discharge of the gas. Further, after initial piercing, the device retains the gas pressure so that no gas is used and the gas can be administered in a plurality of doses. In addition, any screw threads between the user device and the gas supply device are not likely to be subjected to gas pressure, making the action of attaching a device according to the invention to a user device and then detaching it relatively easy.

The gas supply device according to the invention may be used to store and deliver either a permanent or a non-permanent gas. In one example, it may be used to store and deliver a noble gas, for example, helium or argon, or a mixture of helium and argon, to a device for administering a non-thermal gaseous plasma to the oral cavity or other part of the body of a human being for animal). FIG. 5 is a schematic diagram of a held device 601 for generating non-thermal gaseous plasma comprising a housing 602 which defines a docking station 603 receiving a gas supply device 604 according to the invention. In this embodiment, the gas supply device 604 comprises a 21 ml capacity gas capsule. The docking station 603 is provided with a connecting device (not shown). Full insertion of the gas supply device 604 in the docking station 603 causes the closure disc of the gas capsule to be pierced and gas to be released from the gas capsule in the direction of the arrow. The docking station 603 communicates with a gas passage 606 in which a manually operable valve 605 is located. This valve 605 is normally closed so that on piercing the closure disc of the gas capsule, none of the resulting release of gas can pass beyond the valve 605. The valve 605 is provided with a manually operable actuator 608, which can be operated to open the valve 605 to allow gas to pass therethrough. The passage 606 communicates with a cell 610 for generating a non-thermal gaseous plasma, typically at atmospheric pressure. The plasma generator cell 610 is provided with an applicator 612 which is able to be inserted into the oral cavity or as required. Further information about the configuration and use of such devices in oral treatment given in Patent Applications WO 2010/072997A. WO 2010/103262A and WO 2010/103263A, which are all incorporated herein by reference.

The gas supply device 604 may be removed from the docking station 603. As a result of such removal, the valve mechanism described with reference to FIGS. 1 to 3 closes, thereby retaining gas under pressure in the capsule.

1. A gas supply device comprising:
a capsule for storing gas under pressure, the capsule having a mouth;
a closure at the mouth of the capsule in the form of a pierceable, malleable closure disc;
a cap able to be brought into engagement with the capsule to crush the pierceable, malleable disc and thereby seal the capsule;
a gas passage through the cap; and
a valve member in the gas passage, the valve member being integral with or carrying a forward disc-piercing member, and being able to be urged by application of a disc-piercing force to pierce the disc and thereby release gas from the capsule into the gas passage, and having a rearward face which on removal of the disc-piercing force is able to be urged into a valve closing position in which gas is retained under pressure in the capsule.

2. A gas supply device according to claim 1, wherein a fixed and permanent engagement is made between the cap and the capsule.

3. A gas supply device according to claim 1, wherein the cap has an external surface having a configuration enabling the gas supply device to be coupled to another device in which the gas is to be used.

4. A gas supply device according to claim 3, wherein the cap has a coupling nozzle.

5. A gas supply device according to claim 1, wherein the internal surface of the cap has a screw-thread able to engage a complementary screw-thread on the external surface of the capsule.

6. A gas supply device according to claim 1, wherein the external surface of the cap is provided with drive splines to facilitate mechanical tightening of the cap.

7. A gas supply device according to claim 1, wherein the disc is formed of aluminium, a malleable alloy based on aluminium, copper or a malleable alloy based on copper.

8. A gas supply device according to claim 1, wherein the disc has a central pierceable area of reduced thickness.

9. A gas supply device according to claim 1, wherein the disc has a downturned rim.

10. A gas supply device according to claim 9, wherein filling grooves or notches are provided in the rim.

11. A gas supply device according to claim 1, wherein the device includes a spring which has a bias in a valve-closing direction.

12. A gas supply device according to claim 11, wherein the spring is a compression spring.

13. A gas supply device according to claim 12, wherein the compression spring sits on the disc.

14. A gas supply device according to claim 1, wherein the rearward face of the valve member comprises an elastomeric seal which is held under compression when the valve member seats against an internal surface of the cap.

15. A gas supply device according to claim 1, wherein the disc-piercing member is a piercing needle integral with or carried by the valve member.

16. A gas supply device according to claim 15, wherein the piercing needle is hollow.

17. A gas supply device according to claim 1, wherein an external surface of the cap is formed with a coupling screw thread to enable it to be coupled to a gas-using device, the coupling screw thread having an axial extent greater than the distance travelled by the disc-piercing member from its disc-piercing position to its valve closing position.

18. A gas supply device according to claim 1, wherein the valve member is connected to or integral with a valve spindle, the valve spindle being displaceable by external means.

19. A gas supply device according to claim 18, wherein the valve spindle does not protrude out of the cap even when the valve is in its closed position.

20. (canceled)

21. A method of charging with gas a gas supply device wherein the gas supply device comprises:
a capsule for storing gas under pressure, the capsule having a mouth;
a closure at the mouth of the capsule in the form of a pierceable, malleable closure disc;
a cap able to be brought into engagement with the capsule to crush the pierceable, malleable disc and thereby seal the capsule;
a gas passage through the cap; and
a valve member in the gas passage, the valve member being integral with or carrying a forward disc-piercing member, and being able to be urged by application of a disc-piercing force to pierce the disc and thereby release gas from the capsule into the gas passage, and having a rearward face which on removal of the disc-piercing force is able to be urged into a valve closing position in which gas is retained under pressure in the capsule;
wherein the disc has a downturned rim having filling grooves or notches provided therein;
the method comprising:
a) assembling the gas supply device with the malleable, pierceable disc positioned over the mouth of the gas capsule,
b) supplying gas under pressure to the side of the valve member remote from the gas capsule, thereby causing the rearward face of the valve member to move out of its valve-closing position to permit gas to flow past the valve member through the filling grooves of the malleable, pierceable closure disc,
c) ceasing the supply of gas, thereby causing the valve member to return to its valve-closing position, and
d) tightening the cap on the capsule to crush the malleable, pierceable disc, thereby making a gas-tight closure between the malleable, pierceable disc and the gas capsule.

22. (canceled)

23. (canceled)
